(19) United States
(12) Patent Application Publication
(10) Pub. No.: US 2021/0220918 A1
(43) Pub. Date: Jul. 22, 2021

(54) Cutting tool generated from a carbide blank.

(71) Applicant: Jerry Plummer, Beloit, WI (US)

(72) Inventor: Jerry Plummer, Beloit, WI (US)

(21) Appl. No.: 16/749,269

(22) Filed: Jan. 22, 2020

(51) Int. Cl. B23B 27/10

(52) U.S. Cl. CPC B23B 27/10

(57) ABSTRACT

A cutting tool generated from a carbide blank is disclosed for removing material chips from a workpiece. The cutting tool includes an elongate body having a first and a second end and a rotational axis extending through the first and the second end of the elongate body. The second end of the elongate body defines a cutting edge. Additionally, the elongate body defines a bore which extends along the rotational axis such that in use of the cutting tool, a flow of coolant flows through the bore from a pressurized coolant source in a direction from the first end of the elongate body towards the second end of the elongate body. Also, the elongate body defines a plurality of channels which are in fluid communication with the bore.

### CROSS REFERENCE TO RELATED APPLICATION

The present application is a Complete application filed pursuant to Provisional patent application U.S. Ser. No. 62/728,833 filed Sep. 9, 2018. All the disclosure of U.S. Ser. No. 62/728,833 is incorporated herein by reference.

### BACKGROUND OF THE INVENTION

### Field of the invention

The present invention relates to a cutting tool generated from a carbide blank.

More particularly, the present invention relates to a cutting tool generated from a Tungsten carbide blank for removing material from a workpiece.

### Background information

Specialty cutting tools such as twist drills having coolant flowing therethrough are usually generated from Tungsten Carbide blanks. Tungsten Carbide (WC) typically includes a combination of equal amounts of Tungsten powder and powdered carbon. Cobalt is usually added to WC as a binder to increase the toughness of the material. Tungsten is a metal and the resultant WC or cemented carbide is extremely hard after being subjected to a high temperature sintering process. However, prior to sintering, the WC is said to be in the “green state” and can be formed as a cylindrical rod or carbide blank. Many of the features of the carbide blank such as the coolant channels can be formed during the forming process of the WC material prior to sintering. In a typical twist drill blank, the blank is formed with for example three coolant bores which extend through the length of the rod. Each bore is equally spaced and parallel to an adjacent bore. Subsequent to forming, the ends of the blank are twisted relative to each other so that each of the coolant bores follow a spiral configuration with each coolant bore being equally spaced from the outer cylindrical surface of the blank. Sometimes, the relatively soft “green state” blank will be further treated prior to sintering by cutting helical flutes between adjacent coolant bores. The removed WC can then be recycled to produce further blanks.

Specialty tool manufactures purchase the aforementioned sintered blanks and machine a blank to meet the requirements of an end user. The sintered blank is very hard and is much harder than steel. The flutes and cutting edge of the hardened carbide blank are then accurately machined by the specialty tool manufacture to specific dimensions. During such machining, great care must be taken particularly during machining the flutes in order to avoid machining into any of the coolant bores. The machining must carefully follow the lead of the coolant bore and avoid cutting too close to the bore as this would weaken the resultant hollow flute rib disposed between adjacent flutes.

Additionally, because carbide blanks are typically manufactured with helical coolant bores having an angle such as 30 degrees relative to a rotational axis, the flute in this case must also of necessity be machined to 30 degrees relative to the rotational axis. Therefore, the specialty tool manufacturer is limited by the type of carbide blank that is readily available for machining. Although a blank having a non-standard configuration can be special ordered, the cost of such special order is usually prohibitive. Also, it is not uncommon to experience a delay of months when ordering a special blank.

The present invention overcomes the aforementioned problem by starting with a WC blank having a central coolant bore rather than a plurality of spiral coolant bores. Also, the WC blank according to the present invention is shorter than a typical off the shelf extruded blank such as a 30 or 40 degree spiral hole typically sold in 310, 330 and 415 mm length blanks. These shorter blanks permit the manufacturer to drill holes at very high speeds possibly at 10,000 revolutions per minute. These twist drills according to the present invention have a greatly improved chip evacuation capability. By the present invention the specialty tool manufacturer is able to manufacture from a carbide blank a variety of cutting tools and twist drills having many different configurations. Such configurations include a left hand or a right hand twist drill, a drill with flutes having a zero angle, a twist drill having a flute angle less than 30 degrees. For example a twist drill having a flute angle of 10 degrees relative to the rotational axis has a distinct advantage when compared with a 30 degree flute twist drill of the same length. This is because the distance travelled by the chips evacuated from the cutting edge through the flutes is much less than a tool with a greater spiral.

Therefore, for a given rotational speed such as 10,000 revolutions per minute at a depth of 5 inches with a given coolant pressure, the chips will be evacuated in less time with the 10 degree flute than the 30 degree flute twist drill. The reduction in time when using a 10 degree flute results from the fact that the spiral distance travelled by the chips and coolant will be less than the distance travelled when using a 30 degree flute. Therefore, the chance of a chip blockage and attendant drill breakage from chip packing will be less when a 10 degree flute is used.

Also, with a single central coolant bore according to the present invention, when machining the flutes, there is no need to follow a spiral path of the coolant bores.

Furthermore, a multiplicity of flutes can be machined from the aforementioned carbide blank according to the present invention. For example, a blank with a central hole with two exit holes or channels can be used to make a two flute tool, a four flute, six flute or an eight flute drill. A blank with three exits or channels can make a 3, 6, 9 or 12 flute drill.

Moreover, a step type drill can be machined rapidly because there are no spiral coolant bores to avoid cutting into the bolt hole circle pattern of an extruded spiral hole coolant blank typically offered as stock blanks for tool fabricators to select from.

Therefore, a primary feature of the present invention is the provision a cutting tool having a variety of different flute configurations from one type of WC blank or rod thereby providing greater flexibility to a manufacturer of such cutting tools.

Another feature of the present invention is a reduction in cost when manufacturing cutting tools of various configurations.

Other features and advantages of the present invention will be readily apparent to those skilled in the art by a consideration of the detailed description of a preferred embodiment of the present invention contained herein.

### SUMMARY OF THE INVENTION

The present invention relates to a cutting tool generated from a carbide blank. The cutting tool is for removing material from a workpiece. The cutting tool includes an elongate body having a first and a second end and a rotational axis extending through the first and the second end of the elongate body. The second end of the elongate body defines a cutting edge. Additionally, the elongate body defines a bore which extends along the rotational axis such that in use of the cutting tool, a flow of coolant flows through the bore from a pressurized coolant source in a direction from the first end of the elongate body towards the second end of the elongate body. Also, the elongate body defines a plurality of channels which are in fluid communication with the bore. The channels extend from a downstream termination of the bore towards a vicinity of the cutting edge. The elongate body defines a plurality of flutes which during rotation and use of the cutting tool facilitate a further flow of the coolant and the chips removed from the workpiece by the cutting edge through the plurality of flutes towards the first end of the elongate body. The bore is straight and has a relatively large cross sectional area for inhibiting undue restriction of the flow of coolant. The arrangement is such that a spiral flow of coolant is avoided so that a pressure of the coolant from the pressurized coolant source does not dissipate substantially during the flow of coolant through the bore to the cutting edge.

In a more specific embodiment of the present invention, the elongate body is of cylindrical configuration.

Moreover, the bore is disposed coaxially within the elongate body.

Furthermore, the bore has a uniform cross sectional area from the first end of the elongate body to the downstream termination of the bore.

Additionally, each channel of the plurality of channels has a uniform cross sectional area from the downstream termination of the bore towards a vicinity of the cutting edge.

More specifically, each channel of the plurality of channels has a cross sectional area which is equal to a cross sectional area of an adjacent channel.

Also, a sum of the cross-sectional areas of all of the channels of the plurality of channels is equal to the cross sectional area of the bore.

Further, each flute of the plurality of flutes is formed with a maximum cross sectional area while maintaining structural integrity of the elongate body so that each of the flutes avoids exposure of the bore while permitting a maximum evacuation of the chips by the further flow of coolant.

Additionally, each flute of the plurality of flutes has a relatively large cross sectional area in the absence of any adjacent spiral coolant bores so that the chips are easily evacuated by the further flow of coolant from the cutting edge through the flutes towards the first end of the elongate body.

Preferably, each flute of the plurality of flutes defines an angle less than 30 degrees relative to the rotational axis thereby reducing a distance travelled by the chips evacuated by the further flow of coolant from the cutting edge to the first end of the elongate body so that any blockage of the further flow of coolant by the chips is minimized thus reducing the possibility of breakage of the cutting tool.

The elongate body defines a flute rib between each adjacent flute, each flute rib being stronger due to an absence of a coolant bore extending spirally therethrough.

Also, the bore permits a generation of a flexible disposition of the flute along the elongate body because a requirement to follow any spiral bore is avoided.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

Included in such modifications would be the provision of a twist drill in which the channels convey the pressurized coolant to the flutes in a vicinity of the cutting edge rather than to a more typical location slightly behind the cutting edge. This modification is particularly useful for the finish machining of through holes that have been formed in a casting. When finish machining a through hole in a casting using a twist drill with a channel terminating just behind the cutting edge, the coolant will flow straight through such termination and such flow will be directed out of the through hole without lubricating the cutting edge to a significant degree and more importantly, very little if any of the coolant will flow back through the flutes to evacuate chips from the cutting edge. By locating the termination of the channel in a vicinity of the cutting edge but disposed within the flute rather than behind the cutting edge, the coolant flow will still cool the cutting edge and some of the coolant will flow through the flute to lubricate the cutting edge but most of the coolant will generate a further flow of coolant so that such further flow of coolant and chips will convey the chips towards the first end of the elongate body for evacuation of the chips from the through hole.

In a further modification of the present invention, a cutting tool is generated from a carbide blank in which at least 3 helical coolant channels are formed. These channels have a very small helical angle that is within a range of 0 to 25 degrees and preferably within a range of 10 to 20 degrees relative to the rotational axis so that the distance travelled by the chips cut from a workpiece during the drilling of a hole is minimized so that any blockage of the flutes by the chips being evacuated during a drilling process is minimized.

In the case of a blank having the channels extending at 0 degrees relative to the rotational axis of the drill, the three or more flutes will be machined parallel to the rotational axis but spaced from the channels and the chips will travel the shortest possible distance during evacuation of the chips through the flutes. Also, when the coolant channels follow a helical path disposed at an angle of 25 degrees relative to the rotational axis, these chips will travel a greater distance. However, such greater distance will still be considerably less than the distance travelled by chips evacuated through a typical 2-flute 30 degree spiral flute cutting device.

Additionally, the cutting device according to the present invention can be formed from a multi-coolant helical channel blank in which the channels define an angle of 0-25 degrees relative to the rotational axis but having a replaceable cutting portion. The replaceable cutting portion may actually define the cutting edges of the drill. Alternatively, the replaceable portion may be provided with a seating for adjustably receiving therein one or more inserts which define the cutting edges.

### BRIEF DESCRIPTION OF THE DRAWINGS

FIG. 1 is a side elevational view partially in section of a cutting tool according to the present invention;

FIG. 2 is a similar view to that shown in FIG. 1 but shows a carbide blank from which the cutting tool shown in FIG. 1 is generated; and

FIG. 3 is an enlarged sectional view taken on the line 3-3 of FIG. 1.

Similar reference characters refer to similar parts throughout the various views of the drawings.

### DETAILED DESCRIPTION OF THE DRAWINGS

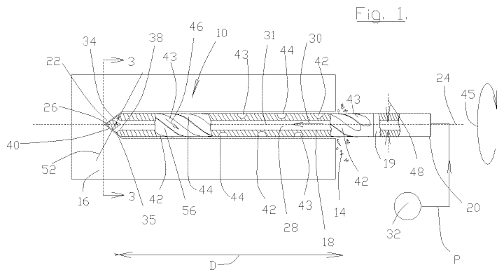

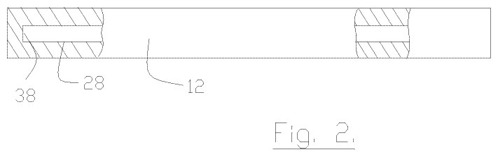

FIG. 1 is a side elevational view partially in section of a cutting tool generally designated 10 according to the present invention.

FIG. 2 is a similar view to that shown in FIG. 1 but shows a carbide blank 12 from which the cutting tool 10 shown in FIG. 1 is generated.

As shown in FIG. 1, the cutting tool 10 is for removing material 14 from a workpiece 16. The cutting tool 10 includes an elongate body generally designated 18 having a first and a second end 20 and 22 respectively and a rotational axis 24 extending through the first and the second end 20 and 22 of the elongate body 18. The second end 22 of the elongate body 18 defines a cutting edge 26. Additionally, the elongate body 18 defines a bore 28 which extends along the rotational axis 24 such that in use of the cutting tool 10, a flow as indicated by the arrow 30 of coolant 31 flows through the bore 28 from a pressurized coolant source 32 in a direction from the first end 20 of the elongate body 18 towards the second end 22 of the elongate body 18.

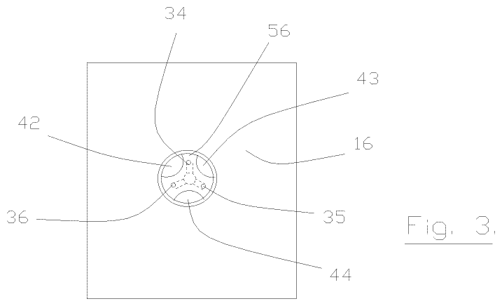

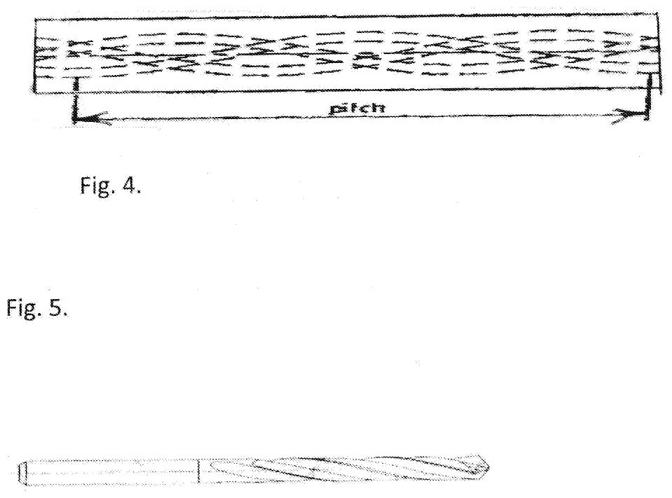

FIG. 3 is an enlarged sectional view taken on the line 3-3 of FIG. 1. As shown in FIG. 3, the elongate body 18 defines a plurality of channels 34, 35 and 36 which are in fluid communication with the bore 28. The channels 34 to 36 extend from a downstream termination 38 of the bore 28 towards a vicinity 40 of the cutting edge 26. The channels 34 to 36 in a three flute twist drill will define an angle of 120 degrees relative to each other. Additionally, each channel will extend outwardly from the downstream termination 38 of the bore 28 at an angle within a range of 15 to 75 degrees relative to the rotational axis 24. The elongate body 18 also defines a plurality of flutes 42, 43 and 44.

As shown in FIG. 1, during rotation of the cutting tool 10, as indicated by the arrow 45 and during use of the cutting tool 10, there is a further flow as indicated by the arrow 46 of the coolant 31 and the chips 14 removed from the workpiece 16. These material chips 14 are removed from the workpiece 16 by the cutting edge 26 during relative rotation between the cutting edge 26 and the workpiece 16. These chips 14 are then evacuated by the coolant 31 from the vicinity 40 of the cutting edge 26 through the plurality of flutes 42 to 44 towards the first end 20 of the elongate body 18. The bore 28 is straight and has a relatively large cross sectional area 48 for inhibiting undue restriction of the flow 30 of coolant 31. The arrangement is such that a spiral flow of coolant 31 is avoided so that a pressure P of the coolant 31 from the pressurized coolant source 32 does not dissipate substantially during the flow 30 of coolant 31 through the bore 28 to the cutting edge 26.

As shown in FIG. 1, the elongate body 18 is of cylindrical configuration.

Also, the first end 20 of the elongate body 18 defines a shank 19.

In a preferred embodiment of the present invention, the bore 28 is disposed coaxially within the elongate body 18.

Furthermore, the bore 28 has a uniform cross sectional area 48 from the first end 20 of the elongate body 18 to the downstream termination 38 of the bore 28.

Additionally, each channel such as channel 34 of the plurality of channels 34 to 36 has a uniform cross sectional area 52 from the downstream termination 38 of the bore 28 towards the vicinity 40 of the cutting edge 26.

More specifically, each channel such as channel 34 of the plurality of channels 34 to 36 has a cross sectional area 52 which is equal to a cross sectional area 54 of an adjacent channel such as channel 35.

Also, a sum of the cross sectional areas 52 and 54 of all of the channels of the plurality of channels 34 to 36 is equal to the cross sectional area 48 of the bore 28.

Those skilled in the art will appreciate that the channels 34 to 36 can be machined by various means that are not economical because of the hardness of the carbide blank. Usually, the number of channels will correspond with the number of flutes. The present invention permits the generation of a wide variety of cutting tool configurations from a universal carbide blank. Accordingly, the resultant twist drill may have any number of flutes and corresponding channels. Also, the channels can be cut before or after machining the flutes 42-44.

Therefore, the specialty tool manufacturer will only need to maintain an inventory which includes a number of universal blanks for each blank or rod of a certain required diameter.

Further, each flute such as flute 42 of the plurality of flutes 42 to 44 is formed with a maximum cross sectional area 48 while maintaining structural integrity of the elongate body 18 so that each of the flutes 42 to 44 avoids exposure of the bore 28 while permitting a maximum evacuation of the chips 14 by the further flow 46 of coolant 31.

Additionally, each flute such as flute 42 of the plurality of flutes 42 to 44 has a relatively large cross sectional area 52 in the absence of any adjacent spiral coolant bores so that the chips 14 are easily evacuated by the further flow 46 of coolant 31 from the cutting edge 26 through the flutes 42 to 44 towards the first end 20 of the elongate body 18.

Preferably, each flute such as flute 42 of the plurality of flutes 42 to 44 defines an angle of less than 30 degrees relative to the rotational axis 24 thereby reducing a distance D travelled by the chips 14 evacuated by the further flow 46 of coolant 31 from the cutting edge 26 to the first end 20 of the elongate body 18. This reduction in the distance D is so that any blockage of the further flow 46 of coolant 31 by the chips 14 is minimized thus reducing the possibility of breakage of the cutting tool 10.

The elongate body 18 defines a flute rib 56 between each adjacent flute such as adjacent flutes 42 and 43. Accordingly, each flute rib 56 is much stronger due to an absence of any spiral coolant bore extending therethrough.

Also, the bore 28 permits the generation of a flute such as flute 42 disposed at any angle along the elongate body 18 relative to the rotational axis 24 because a requirement to follow and avoid cutting into any spiral bore is not required.

In operation of the present invention, the specialty tool manufacturer can purchase from a supplier of carbide blanks a relatively large number of such blanks having a blind bore 28 extending therethrough but without any initial spiral flutes formed therein. The blanks or rods will be of a considerable length such as 15 inches so that, if required by the end user, the resultant machined cutting tool such as a twist drill will be capable of consistently and reliably cutting a deep hole at great speed without any blockage of chips and the attendant breakage of the twist drill.

The specialty tool manufacturer will at this stage achieve a first cost saving because normally the carbide blank manufacturer will charge extra for providing a blank with preformed flutes therein for final machining. According to the present invention, the carbide blank will be purchased without any preformed non-machined flutes.

According to the present invention, the second financial advantage to the specialty tool manufacturer will be that virtually any twist drill configuration for this diameter blank can then be machined from the blank because the specialty tool manufacturer will not be restricted by any one flute angle or be required to machine to a certain flute angle in order to avoid cutting into the typical spiral coolant bores of a regular carbide blank.

A third manufacturing cost saving to the specialty tool manufacturer will be realized because the machining of the flutes can be performed more rapidly. This rapid machining of the flutes is possible according to the present invention, since there is no requirement to carefully machine the flute to avoid cutting into any adjacent spiral coolant bore.

The present invention additionally and very importantly enables the specialty tool manufacturer to start with a carbide blank or rod having a central coolant bore having a considerably smaller diameter which will accommodate the variety of coolant pressure systems used by the various end users. This means that regardless of the type of pressure system used by the end user for pumping coolant through the straight central coolant bore, the pressure will be sufficient to reliably evacuate the chips even when cutting holes at high speeds. This advantage is achieved firstly, because of the relatively small diameter of the central coolant bore. Also, secondly, because a central straight coolant bore is provided in the cutting tool of the present invention rather than a plurality of spiral bores. Thus, the coolant pressure supplied by the source of coolant is almost entirely transmitted through the coolant bore 28 to the cutting edge 26. This maintenance of pressure is achieved because with the straight central bore 28, there is no centrifugal force applied to the coolant 31 that in the case of a spiral bore would tend to reduce the available pressure of coolant 31 at the cutting edge 26. Those skilled in the art will appreciate that particularly, when the end user is drilling holes such as 4 inch deep holes at very high speeds of for example 10,000 revolutions per minute, much heat is generated at the cutting edge 26. Accordingly, in order to dissipate this thermal energy, coolant to the point of cutting action is recommended to sustain sharp cutting edges on the tool longer, However, the coolant in a prior art multiple spiral coolant cutting tool, has a coolant pressure that will decrease and the centrifugal force of the coolant outwardly against the walls of the spiral coolant bores will of necessity increase. Also, because the columns of coolant within the spiral coolant bores are rotating at extremely high speeds and these columns of coolant are at a greater radial distance from the rotational axis of the cutting tool than in the case of the corresponding central coolant column of the present invention, the centrifugal force pressing the coolant outwardly against the walls of the spiral bores will be much greater. Therefore, the resultant coolant pressure available at the cutting edge using the prior art spiral coolant bores will be correspondingly reduced by the pressure lost due to the inherently increased centrifugal force. This is because of the auguring action due to the spiral coolant bores or coolant passages through the tool on a right hand spiral and right hand cutting drills with coolant bores inside the flute ribs.

Furthermore, according to the present invention, as a result of the provision of a straight central coolant bore 28, the size or cross sectional area of the flutes can be increased. Consequently, the chip evacuating capacity of the flutes will be increased in the cutting tool according to the present invention when compared with a more conventional spiral coolant bore cutting tool.

In addition to increasing the cross sectional area of the flutes, the specialty tool manufacturer is permitted to machine the flutes to a lesser angle thus reducing the distance that the chips 14 have to travel to reach the first end 20 of the elongate body 18. This reduction in the distance D travelled by the chips 14 means that for a given pressure P of coolant 31, the chips 14 will be evacuated faster thus further reducing the chances of a chip blockage and consequential tool breakage.

Additionally, because the use of a straight central coolant bore permits the machining of a helical flute of a lesser angle, the effect of the considerable centrifugal force applied to the chips at high rotational speeds of 10,000 rpm and above is less in a for example a 10 degree flute than a 40 degree flute. More specifically, although the centrifugal force of the chips 14 urging the chips 14 outwardly against the walls of the flutes 42 to 44 and the hole being cut in the workpiece 16, is the same for a 10 degree flute and a 40 degree flute, the resultant evacuating force R applied to the chips 14 will be greater in a 10 degree flute than a 40 degree flute.

According to the present invention, the specialty tool manufacturer has the great advantage of being able to provide the end user with a cutting tool having a lesser flute angle without the need for ordering a high cost special blank together with the associated long supply delay for special order blanks.

Various types of cutting tools including multiple step cutting tools and even zero angle flutes and left hand spiral flutes can be machined by the specialty tool manufacturer from their own inventory of universal blanks or rods using known machining techniques resulting in considerable savings in cost and time.

The central bore with channel exits will have more pressure and less volume of flow than an extruded spiral hole blank. The inventor is of the opinion that the central bore provides more pressure and that this aids in tool performance more than the volume of the coolant.

The present invention provides a unique arrangement for manufacturing a multiplicity of cutting tools for end users from a universal carbide blank without the need of costly special order shipments.

### LIST OF PARTS

10. cutting tool
12 carbide blank.
14. chips
16. workpiece
18. elongate body
20. first end (of elongate body 18)
22. second end (of elongate body 18)
24 rotational axis
26 cutting edge
28 bore
30 arrow (flow of coolant 31)
31 coolant
32 pressurized coolant source
34 channel (of plurality of channels)
35 channel (of plurality of channels)
36 channel (of plurality of channels)
38 downstream termination (of bore 28)
40 vicinity (of cutting edge 26)
42 flute (of plurality of flutes)
43 flute (of plurality of flutes)
44 flute (of plurality of flutes)
45 arrow (showing rotation of the cutting tool 10)
46 further flow (of coolant 31 and chips 14)
48 cross sectional area (of bore 28)
P pressure (of the coolant 31)
52 uniform cross sectional area (of channel 34)
54 cross sectional area (of an adjacent channel such as channel 35).
56 flute rib

What is claimed is:

1. A cutting tool generated from a carbide blank for removing chips from a workpiece, said cutting tool comprising:
an elongate body having a first and a second end and a rotational axis extending through said first and said second end of said elongate body, said second end of said elongate body defining a cutting edge, said elongate body defining a bore which extends along said rotational axis such that in use of the cutting tool, a flow of coolant flows through said bore from a pressurized coolant source in a direction from said first end of said elongate body towards said second end of said elongate body, said elongate body defining a plurality of channels in fluid communication with said bore, said channels extending from a downstream termination of said bore towards a vicinity of said cutting edge, said elongate body defining a plurality of flutes which during relative rotation of the cutting tool relative to the workpiece and in use of the cutting tool, facilitates a further flow of said coolant and the chips removed from the workpiece by said cutting edge, through said plurality of flutes towards said first end of said elongate body; and
said bore being straight and having a relatively large cross sectional area for inhibiting undue restriction of said flow of coolant and such that a spiral flow of coolant is avoided so that a pressure of the coolant from the pressurized coolant source does not dissipate substantially during said flow of coolant through said bore to said vicinity of said cutting edge.

2. A cutting tool as set forth in claim 1 wherein
said elongate body is of cylindrical configuration.

3. A cutting tool as set forth in claim 1 wherein
said first end of said elongate body defines a shank.

4. A cutting tool as set forth in claim 1 wherein
said bore is disposed coaxially relative to said rotational axis.

5. A cutting tool as set forth in claim 1 wherein
said bore has a uniform cross sectional area from said first end of said elongate body to said downstream termination of said bore.

6. A cutting tool as set forth in claim 1 wherein
each channel of said plurality of channels has a uniform cross sectional area from said downstream termination of said bore towards a vicinity of said cutting edge.

7. A cutting tool as set forth in claim 1 wherein
each channel of said plurality of channels has a cross sectional area which is equal to a cross sectional area of an adjacent channel.

8. A cutting tool as set forth in claim 7 wherein
a sum of said cross sectional areas of all of said channels of said plurality of channels is equal to a cross sectional area of said bore.

9. A cutting tool as set forth in claim 1 wherein
each flute of said plurality of flutes is formed with a maximum cross sectional area while maintaining structural integrity of said elongate body so that each of said flutes avoids exposure of said bore while permitting a maximum evacuation of the chips by said further flow of coolant.

10. A cutting tool as set forth in claim 1 wherein
each flute of said plurality of flutes has a relatively large cross sectional area in the absence of any adjacent spiral coolant bores so that the chips are easily evacuated by said further flow of coolant from said cutting edge through said flutes towards said first end of said elongate body.

11. A cutting tool as set forth in claim 1 wherein
each flute of said plurality of flutes defines an angle less than 30 degrees relative to said rotational axis thereby reducing a distance travelled by the chips evacuated by said further flow of coolant and the chips from said cutting edge to said first end of said elongate body so that any blockage of said further flow of coolant is minimized thus reducing any possibility of breakage of the cutting tool.

12. A cutting tool as set forth in claim 1 wherein
said elongate body defines a flute rib between each adjacent flute, each flute rib being stronger due to an absence of a coolant bore extending spirally therethrough.

13. A cutting tool as set forth in claim 1 wherein
said bore permits a generation of a variety of angular dispositions of said flute along said elongate body because a requirement to follow any spiral bore is avoided;
each flute of said plurality of flutes defines an angle less than 30 degrees relative to said rotational axis thereby reducing a distance travelled by the chips evacuated by said further flow of coolant from said cutting edge to said first end of said elongate body so that any blockage of said further flow of coolant by the chips is minimized thus reducing any possibility of breakage of the cutting tool.

14. A cutting tool generated from a carbide blank for removing chips from a workpiece, said cutting tool comprising:
an elongate body having a first and a second end and a rotational axis extending through said first and said second end of said elongate body, said second end of said elongate body defining a cutting edge, said elongate body defining a bore which extends along said rotational axis such that in use of the cutting tool, a flow of coolant flows through said bore from a pressurized coolant source in a direction from said first end of said elongate body towards said second end of said elongate body, said elongate body defining a plurality of channels in fluid communication with said bore, said channels extending from a downstream termination of said bore towards a vicinity of said cutting edge, said elongate body defining a plurality of flutes which during rotation and use of the cutting tool facilitate a further flow of said coolant and the chips removed from the workpiece by said cutting edge through said plurality of flutes towards said first end of said elongate body;
said bore being straight and having a relatively large cross sectional area for inhibiting undue restriction of said flow of coolant and such that a spiral flow of coolant is avoided so that a pressure of the coolant from the pressurized coolant source does not dissipate substantially during said flow of coolant through said bore; and
each flute of said plurality of flutes having a relatively large cross sectional area in the absence of any adjacent spiral coolant bore so that the chips are easily evacuated by said further flow of coolant from said cutting edge through said flutes towards said first end of said elongate body.

15. A cutting tool generated from a carbide blank for removing chips from a workpiece, said cutting tool comprising:
an elongate body having a first and a second end and a rotational axis extending through said first and said second end of said elongate body, said second end of said elongate body defining a cutting edge, said elongate body defining a bore which extends along said rotational axis such that in use of the cutting tool, a flow of coolant flows through said bore from a pressurized coolant source in a direction from said first end of said elongate body towards said second end of said elongate body, said elongate body defining a plurality of channels in fluid communication with said bore, said channels extending from a downstream termination of said bore towards a vicinity of said cutting edge, said elongate body defining a plurality of flutes which during relative rotation of the cutting tool relative to the workpiece and in use of the cutting tool, facilitates a further flow of said coolant and the chips removed from the workpiece by said cutting edge, through said plurality of flutes towards said first end of said elongate body;
said bore being straight and having a relatively large cross sectional area for inhibiting undue restriction of said flow of coolant and such that a spiral flow of coolant is avoided so that a pressure of the coolant from the pressurized coolant source does not dissipate substantially during said flow of coolant through said bore to said vicinity of said cutting edge;
said elongate body being of cylindrical configuration;
said first end of said elongate body defining a shank;
said bore being disposed coaxially relative to said rotational axis;
said bore having a uniform cross sectional area from said first end of said elongate body to said downstream termination of said bore;
each channel of said plurality of channels having a uniform cross sectional area from said downstream termination of said bore towards a vicinity of said cutting edge;
each channel of said plurality of channels having a cross sectional area which is equal to a cross sectional area of an adjacent channel;
a sum of said cross sectional areas of all of said channels of said plurality of channels being equal to a cross sectional area of said bore;
each flute of said plurality of flutes is formed with a maximum cross sectional area while maintaining structural integrity of said elongate body so that each of said flutes avoids exposure of said bore while permitting a maximum evacuation of the chips by said further pressure of coolant;
each flute of said plurality of flutes has a relatively large cross sectional area in the absence of any adjacent spiral coolant bores so that the chips are easily evacuated by said further flow of coolant from said cutting edge through said flutes towards said first end of said elongate body;
each flute of said plurality of flutes defining an angle of less than 30 degrees relative to said rotational axis thereby reducing a distance travelled by the chips evacuated by said further pressure flow of coolant and the chips from said cutting edge to said first end of said elongate body so that any blockage of said further flow of coolant is minimized thus reducing any possibility of breakage of the cutting tool;
said elongate body defining a flute rib between each adjacent flute, each flute rib being stronger due to an absence of a coolant bore extending spirally therethrough; and
said bore permitting a generation of a variety of angular dispositions of said flute along said elongate body because a requirement to follow any spiral bore is avoided.

16. a cutting tool for cutting a hole in a workpiece, said cutting tool comprising:
an elongate body having a first and a second end:
said elongate body being fabricated from a carbide blank which defines at least 3 helical coolant channels, said channels being disposed angularly relative to a rotational axis of said elongate body for subsequently permitting machining of a flute between each adjacent channel;
each flute guiding a flow of chips and coolant therethrough as the chips are cut from the workpiece during cutting of the hole in the workpiece; and
said channels being disposed at an angle within a range of 1 to 25 degrees relative to said rotational axis for minimizing the distance travelled by the chips through said flutes during evacuation thereof thereby inhibiting blockage of said flutes by the chips.
